(19) United States
(12) Patent Application Publication
(10) Pub. No.: US 2003/0137523 A1
(43) Pub. Date: Jul. 24, 2003

(54) Enhanced blending unit performance in graphics system

(75) Inventor: Charles F. Marino, Vestal, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/057,817

(22) Filed: Jan. 22, 2002

(51) Int. Cl. G09G 5/00

(52) U.S. Cl. 345/629

(57) ABSTRACT

Enhanced blending unit performance in a graphics system is provided by reconfiguring a graphics system blending unit to perform at least two multiplier operations. In one embodiment the blending unit includes a reconfigurer that bit slices multipliers, e.g., such as an 8×8 multiplier, into multiple multipliers. A digital video system using this blending unit can provide many of the desirable graphics features and at a lower cost because it utilizes less silicon.

### BACKGROUND OF THE INVENTION

1. Technical Field

The present invention relates generally to a blending unit in a graphics system, and more particularly to enhanced performance of a graphics system blending unit.

2. Related Art

Digital video systems, such as those found in set-top box systems, are increasingly becoming more and more sophisticated with each new generation of digital video. For instance, in set-top boxes, graphics originally included the display of a program guide. However, more processor demanding features such as Internet browsing, e-mail, games, and other multimedia applications are now more readily available. In order to address the processing requirements, digital video systems are provided with a dedicated graphics system, i.e., a graphics engine, scaler, etc.

One part of a graphics system through which many desirable graphics features are created is a blending unit, which can perform a large variety of image blending activities. In one example, images can be joined to fade from one image, called the source image, to another image, called the destination image. This activity is sometimes referred to as morphing. In any blending activity, the calculation that is performed occurs pixel by pixel relative to the source and destination image. For instance, for the morphing example, the new image may be calculated according to the equation: Image_{new}=α*Image_{source}+(1−α)*Image_{destination}. In this equation, a is a percentage, stated in integer form, that determines the amount of each image that is taken to form the new image. The a value can change from pixel to pixel. Other exemplary blending activities include: fading to a color, add a color, fading to black, etc.

Each blending activity usually requires a multiplier in the blending unit to generate the resulting or new pixel value. Since each pixel format may include a number of bits, e.g., 16 bit and 32 bit images are common, a number of multipliers are usually necessary to form one new pixel. As an example, at least four 8 bit by 8 bit multipliers are required to generate one red-green-blue (RGB) pixel format pixel with an a.

A situation that complicates blending is where the source and destination pixel formats are different sizes per component. For example, four full 8 bit by 8 bit (8×8) multipliers are required to blend two images having a 32 bit RGB 8888 pixel format. The number code 8888 indicates the bits/pixel of each parameter. That is, RGB 8888 includes 8 bits/pixel of red parameter, 8 bits/pixel of green parameter, 8 bits/pixel of blue parameter and 8 bits/pixel of the a parameter. However, other pixel formats do not necessarily require full 8×8 multipliers. For instance, four 5 bit by 5 bit (5×5) multipliers and two 6 bit by 6 bit (6×6) multipliers are required for a 16 bit RGB 565 pixel format (5 20 bits/pixel red and blue and 6 bits/pixel green); six 5×5 multipliers are required for a 16 bit RGB 1555 pixel format (1 bit/pixel for a and 5 bits/pixel for each color); and eight 4×4multipliers are required for a 16 bit RGB 4444 pixel format (4 bit/pixel each color and for α). The number of pixels calculated per cycle for each of the above set-ups is two.

One option to address the above problem has been to use 8×8 multipliers and simply force the partial product terms of the full adder array to zeroes. However, this still requires needless processing of each element in the array and limits the number of pixels that can be processed per cycle. In addition, staging latches are required to hold the processed pixels until 32 bits of pixel data can be advanced to the next stage of the graphics engine pipeline.

Another option is to limit the blending unit to operate on one pixel per cycle. However, this reduces the throughput in half for the above pixel formats.

In view of the foregoing, there is a need in the art for a digital video system blending unit that can provide more efficient performance so that desired graphic features can be provided.

### SUMMARY OF THE INVENTION

The invention includes a graphics system blending unit that bit slices multipliers, e.g., such as an 8×8 multiplier, so at least two multiplier operations can be performed per cycle per multiplier. The graphics system using this blending unit can provide many of the desirable graphics features and at a lower cost because it utilizes less silicon.

A first aspect of the invention is directed to a method of blending at least two images using a blending unit in a graphics engine, the blending unit including a plurality of multipliers, the method comprising the steps of: receiving a request for blending the at least two images, each image having a pixel format; and reconfiguring each blending unit multiplier to perform at least two operations per cycle.

A second aspect of the invention is directed to a graphics system having a blending unit, the blending unit comprising: a plurality of multipliers; and a reconfiguration module that reconfigures each multiplier of the blending unit to perform at least two operations per cycle.

A third aspect of the invention is directed to a digital video system comprising: a processor; a memory; an application resident in memory; and a graphics system for generating graphics, the graphics system including: a blending unit including a plurality of multipliers, and means for reconfiguring each multiplier of the blending unit to perform at least two operations per cycle.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a block diagram of a digital video system having enhanced graphics system blending unit performance;

FIG. 2 shows a block diagram of details of the blending unit; FIG. 3 shows an array of full adders for an 8 bit by 8 bit multiplier;

FIG. 4 shows a block diagram of an element of the array;

FIG. 5 shows a schematic representation of bit slicing of the array of FIG. 3;

FIG. 6 shows a 6×6 array bit sliced from the array as shown in FIG. 5;

FIG. 7 shows a 5×5 array bit sliced from the array as shown in FIG. 5; and

FIGS. 8 and 9 show 4×4 arrays bit sliced from the array shown in FIG. 3.

### DETAILED DESCRIPTION OF THE INVENTION

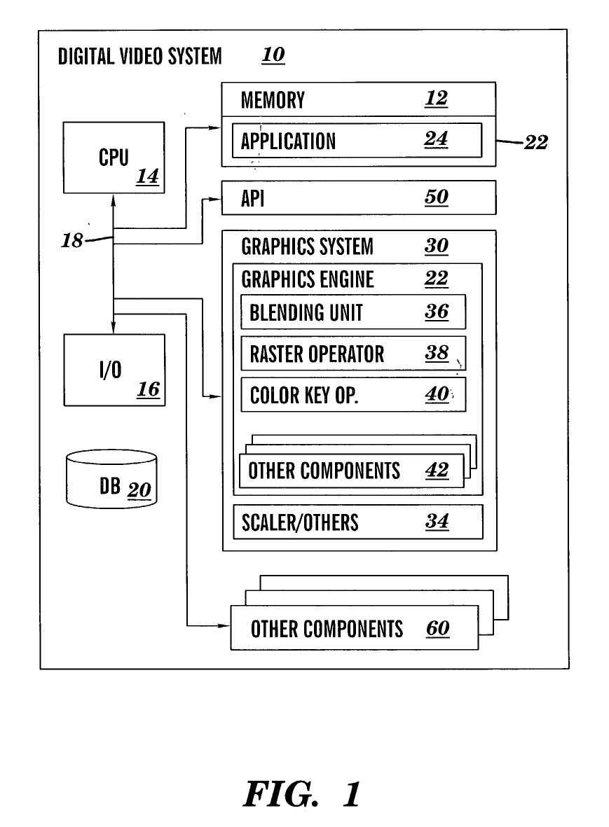

With reference to the accompanying drawings, FIG. 1 is a block diagram of a digital video system 10. Digital video system 10 may include a memory 12, a central processing unit (CPU) 14, input/output devices (I/O) 16 and a bus 18. A database 20 may also be provided for storage of data relative to processing tasks. Memory 12 (and database 20) may comprise any known type of data storage system and/or transmission media, including magnetic media, optical media, random access memory (RAM), read only memory (ROM), a data object, etc. Moreover, memory 12 (and database 20) may reside at a single physical location comprising one or more types of data storage, or be distributed across a plurality of physical systems.

Processor 14 may likewise comprise a single processing unit, or a plurality of processing units distributed across one or more locations. In one embodiment, digital video system 10 is a set top box configured to provide various digital television service functionality including generating graphics for overlay in a television display. In this setting, processor 14 may comprise an IBM PowerPC® CPU. Processor 14 is designed to drive the operation of the particular hardware and is compatible with other system components and I/O controllers. I/O 16 may comprise any known type of input/output device including a network system, modem, keyboard, mouse, scanner, voice recognition system, CRT, printer, disc drives, etc.

As shown in FIG. 1, memory 12 includes a program product 22 that, when executed by CPU 14, comprises various functional capabilities of system 10. For example, application 24 may generate program guide graphics for a set top box, graphics for a video game, etc. The teachings of the invention are applicable to practically any environment requiring a digital blending of images.

Digital video system 10 also includes a graphics system 30 that includes a graphics engine 32 and other components such as a scaler 34. Graphics engine 32 may comprise hardware that performs graphics processing tasks based on requests from application 24. Scaler 34 may comprise hardware that performs enlargement or reduction of graphics based on requests from application 24. Graphics engine 32 includes a blending unit 36 and may include other now known or later developed components such as a raster operator 38, color key operator 40, and other components 42. Other components 42 may include, for example, a pixel bit mask operator, a pattern write mask operator, a pixel boundary modify write operator, etc. An application program interface (API) 50 is provided for communication between application 24 and graphics system 30. Additional components 60, such as cache memory, communication systems, cable television peripherals, etc., may also be incorporated into system 10.

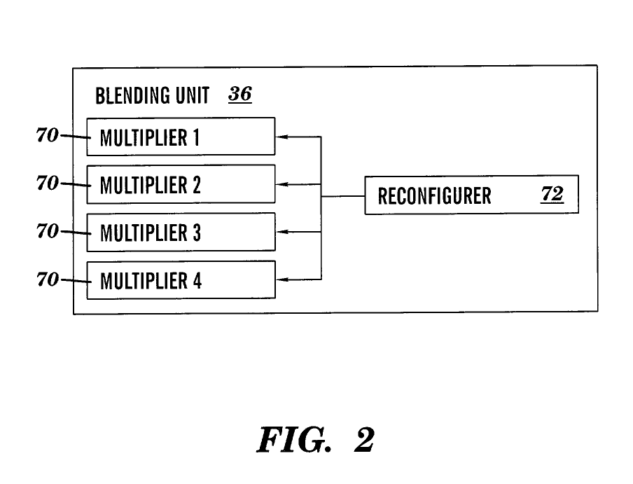

Referring to FIG. 2, blending unit 36 is provided to perform a large variety of compositing operations. Each compositing operation usually requires a multiplier to operate pixel by pixel on the source and destination image. For instance, for a morphing of images, the new image may be calculated according to the equation: Image_{new}=α*Image_{source}+(1−α)*Image_{destination}, where α is a percentage, stated in integer form, that determines the amount of each image that is taken to form the new image. The α value can change from pixel to pixel.

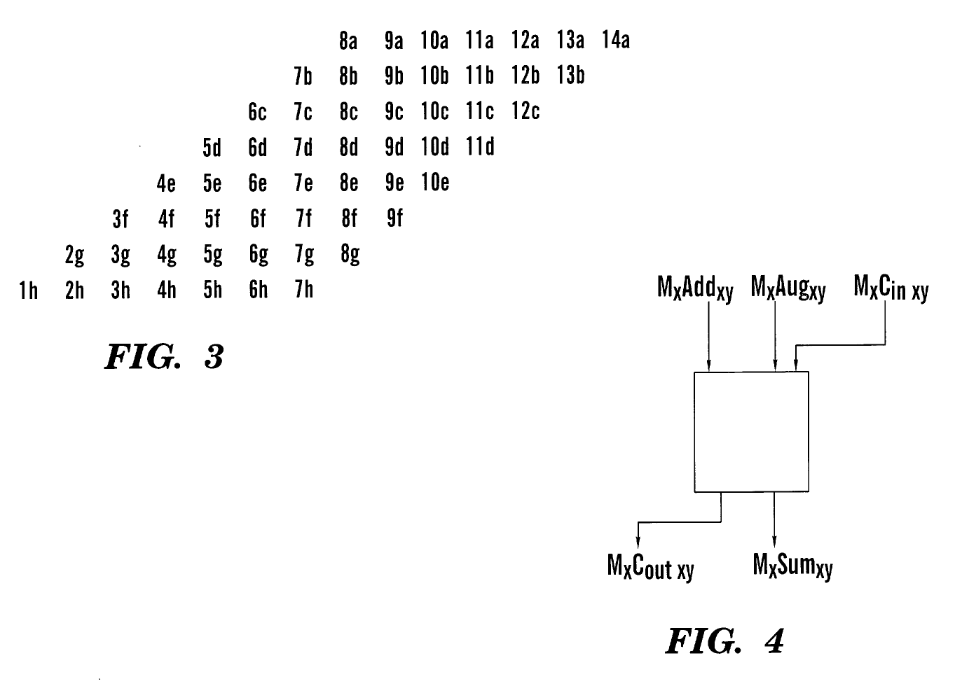

In one embodiment, blending unit 36 includes four 8 bit by 8 bit multipliers 70. A full adder array for each multiplier 70 is shown in FIG. 3. FIG. 4 illustrates the interrelation of each full adder array element to other elements in the shift adders of multipliers 70. In particular, each element includes three inputs: MₓAdd_{xy} is the initial partial product term for that element; MₓAug_{xy} is the augend passed from an immediately vertically adjacent element or a partial product term for those elements not having an element above; and MₓC_{in xy} is a carry term from an element in the column to the right and the row above (unless the element is in the bottom row in which the carry term is from an element 1 to the right within the same row). Each element has two outputs: MₓSum_{xy} is the sum of the inputs excepting any carry; and MₓC_{out xy} is the carry term to an element in the column to the left and the row below (unless the element is in the bottom row in which the carry term is to an element to the left within the same row).

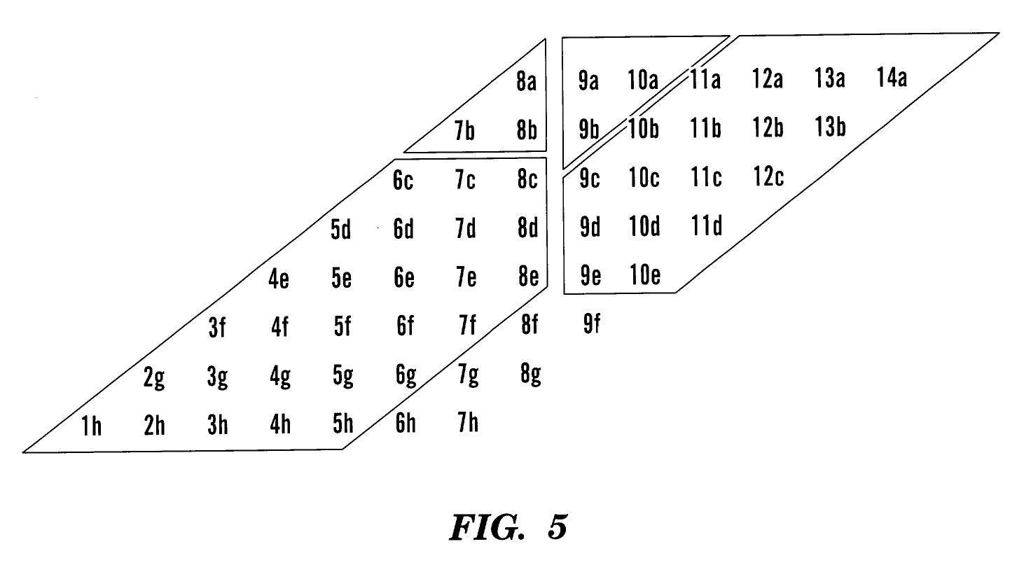

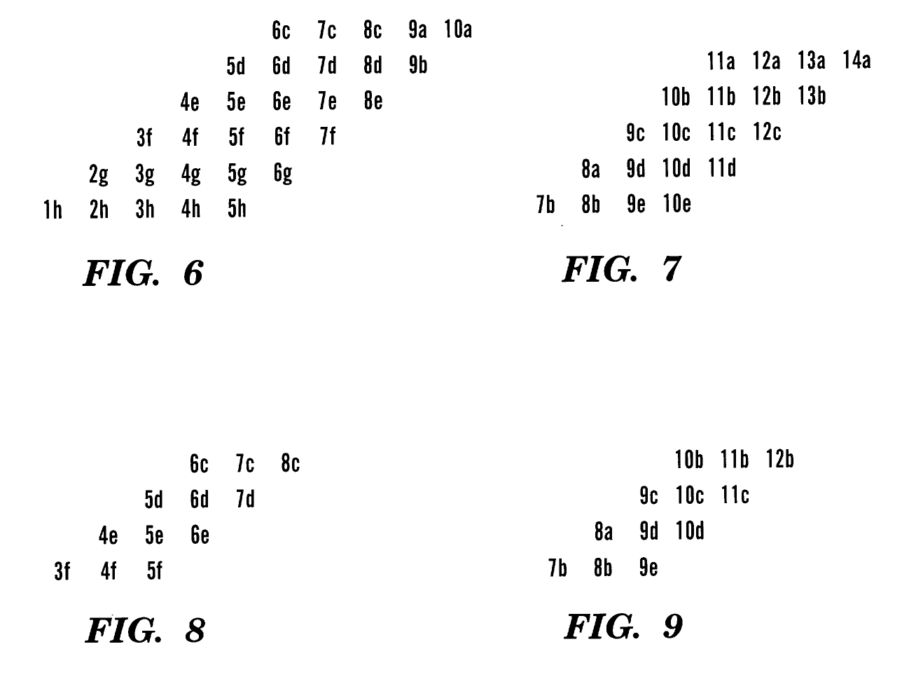

With continuing reference to FIG. 2, blending unit 36 includes a reconfigurer (or reconfiguration module) 72 that is operative to bit slice each multiplier 70 in order to perform at least two multiplier operations per cycle. FIGS. 5-7 illustrate how an 8 bit by 8 bit multiplier can be bit sliced to form a 6×6 multiplier (FIG. 6) and a 5×5 multiplier (FIG. 7). In this particular form, six elements are not used: 8f, 9f, 7g, 8g, 6h and 7h. Similarly, FIGS. 8 and 9 illustrate two 4×4 bit sliced multipliers that can be formed from a single 8 bit by 8 bit multiplier.

Reconfigurer 72 determines which way to bit-slice multipliers 70 according to the pixel format that is input. For instance, an RGB 565 pixel format would cause multipliers 70 to be bit-sliced as shown in FIGS. 6 and 7. With four multipliers 70, as shown in FIG. 3, each is bit sliced into a 6×6 multiplier and a 5×5 multiplier such that two multiplier operations can be performed per multiplier 70 per cycle, i.e., 8 multiplier operations per cycle. Similarly, an RGB 4444 pixel format would cause multipliers 70 to be bit sliced as shown in FIGS. 8 and 9 to allow for the same result for a pixel format requiring 4×4 multipliers.

Using graphics system 30 having blending unit 36, the number of multiplier operations that can be performed per cycle can be increased. A digital video system 10 using blending unit 36 can provide many of the desirable graphics features and at a lower cost because it utilizes less silicon. Bit slicing of the four 8×8 multipliers 70, as described, results in relatively inexpensive implementation for a two-time performance improvement.

The invention also includes a method of blending at least two images using a blending unit in a graphics engine comprising the steps of: receiving a request for blending the at least two images in blending unit 36, each image having a pixel format; and reconfiguring each blending unit multiplier 70 to perform at least two operations per cycle using reconfigurer 72. The request for blending may be formulated by application 24. The step of reconfiguring includes bit slicing each multiplier according to the pixel format, as described above. The step of bit slicing may also include bit slicing each multiplier to accommodate a first bits/pixel parameter of the format and bit slicing each multiplier to accommodate a second bits/pixel parameter of the format. For instance, where images of an RGB 565 pixel format are being blended, reconfigurer 72 would bit slice to create a 6×6 multiplier for the 6 bits/pixel parameter and then to create a 5×5 multiplier for the 5 bits/pixel parameters. The first bits/pixel parameter is a highest bits/pixel parameter of the format. The highest bits/pixel parameter is no higher than 8 bits/pixel and no less than 1 bit/pixel. As described above, in one embodiment, each blending unit multiplier is, at its core, an 8 bit-by-8 bit multiplier.

In the previous discussion, it will be understood that the method steps discussed are performed by a processor, such as CPU 14 of system 10. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A method of blending at least two images using a blending unit in a graphics engine, the blending unit including a plurality of multipliers, the method comprising the steps of:
receiving a request for blending the at least two images, each image having a pixel format; and
reconfiguring each blending unit multiplier to perform at least two operations per cycle.

2. The method of claim 1, wherein the step of reconfiguring includes bit slicing each multiplier according to the pixel format.

3. The method of claim 1, wherein the step of bit slicing includes bit slicing each multiplier to accommodate a first bits/pixel parameter of the pixel format.

4. The method of claim 3, wherein the step of bit slicing includes bit slicing each multiplier to accommodate a second bits/pixel parameter of the pixel format.

5. The method of claim 3, wherein the first bits/pixel parameter is a highest bits/pixel parameter of the pixel format.

6. The method of claim 5, wherein the highest bits/pixel parameter is no higher than 8 bits/pixel and no less than 1 bit/pixel.

7. The method of claim 1, wherein each blending unit multiplier is an 8 bit-by-8 bit multiplier.

8. A graphics system having a blending unit, the blending unit comprising:
a plurality of multipliers; and
a reconfiguration module that reconfigures each multiplier of the blending unit to perform at least two operations per cycle.

9. The graphic system of claim 8, wherein the reconfiguration module bit slices each multiplier according to a pixel format.

10. The graphics system of claim 8, wherein the reconfiguration module bit slices each multiplier to accommodate a first bits/pixel parameter of a pixel format, and then a second bits/pixel parameter of the pixel format.

11. The graphics system of claim 8, wherein the blending unit is part of a graphics engine.

12. The graphics system of claim 8, wherein the graphics engine further comprises at least one of a raster operator, a color key operator, a pixel bit mask operator, a patter write mask operator and a pixel boundary modify write operator.

13. A digital video system comprising:
a processor;
a memory;
an application resident in memory; and
a graphics system for generating graphics, the graphics system including:
a blending unit including a plurality of multipliers, and
means for reconfiguring each multiplier of the blending unit to perform at least two operations per cycle.

14. The system of claim 13, wherein the means for reconfiguring bit slices each multiplier according to a pixel format.

15. The system of claim 13, wherein the means for reconfiguring bit slices each multiplier to accommodate a first bits/pixel parameter of the format, and then a second bits/pixel parameter of the format.

16. The system of claim 13, wherein the means for reconfiguring is part of a graphics engine.

17. The system of claim 16, wherein the graphics engine further comprises at least one of a raster operator, a color key operator, a pixel bit mask operator, a pattern write mask operator and a pixel boundary modify write operator.

18. The system of claim 13, wherein the graphics system further comprises a scaler.
